(19) United States
(12) Patent Application Publication
(10) Pub. No.: US 2006/0266897 A1
(43) Pub. Date: Nov. 30, 2006

(54) Holder for a securing element of a child seat

(75) Inventors: Dirk Beisheim, Althengstett (DE); Joerg Hirschkorn, Boeblingen (DE); Helmut Kull, Esslingen (DE); Markus Scholz, Waldenbuch (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/407,982

(22) Filed: Apr. 21, 2006

(30) Foreign Application Priority Data
Apr. 22, 2005 (DE) 10 2005 018 831.1

(51) Int. Cl. F16M 11/00

(52) U.S. Cl. 248/200

(57) ABSTRACT

A holder for a securing element of a child seat serves to hold the upper region of a backrest of the child seat on a supporting structure of a motor vehicle, and has a receiving region for the securing element. In order to improve the anchorage of the child seat in the upper region, the holder has a spacer device. When the holder is fitted to the supporting structure of the motor vehicle, the receiving region is held by the spacer device at a predetermined distance from the supporting structure.

This application claims the priority of German application 10 2005 018 831.1, filed Apr. 22, 2005, the disclosure of which is expressly incorporated by reference herein.

### BACKGROUND AND SUMMARY OF THE INVENTION

The present invention relates to a holder for a securing element of a child seat, the holder serving to hold the upper region of a backrest of the child seat on a supporting structure of a motor vehicle and having a receiving region for the securing element.

German document DE 27 12 917 A1 discloses a child safety shell-type seat with an upper holding strap. The upper holding strap can be secured by a holding tab on the rear parcel shelf of a motor vehicle behind the rear seat.

German document DE-U 75 08 270 discloses a child safety shell-type seat which can be secured by an upper clamping strap with the aid-of a turn buckle swivel on a holding plate which can be fixed, for example, on the rear parcel shelf of the motor vehicle or at another stable location on the bodywork.

German document DE 25 51 419 C3 discloses a device for securing occupants in motor vehicles, the device comprising an automatic retractor arranged below a rear parcel shelf.

German document DE-U 71 47 785 discloses a child safety seat for vehicles which is secured on the vehicle bodywork by means of a strap mechanism.

German document DE 198 07 318 A1 discloses a holding device for a child seat, which connects an upper securing point on the child seat to the bar of a rollover protection device.

German document DE 26 50 182 A1 discloses a child car seat which is anchored fixedly to the vehicle bodywork at one point or at two points.

It is an object of this invention to provide a holder for a securing element of a child seat which serves to hold the upper region of a backrest of the child seat on a supporting structure of a motor vehicle and which has a receiving region for the securing element. By means of the holder, the anchorage of the child seat in the upper region can be improved.

To achieve the object, a holder having the claimed features is proposed. The holder has a spacer device by means of which, when the holder is fitted to the supporting structure of the motor vehicle, the receiving region is held at a predetermined distance from the supporting structure. The securing element is preferably fitted to one end of a securing strap, the other end of which is secured in the upper region of the backrest of the child seat. The anchorage of the child seat in the upper region on the supporting structure of the motor vehicle with the aid of the securing strap is also referred to as top tether anchorage and serves, when severe decelerations occur, such as in the case of an accident or emergency braking, to reduce or prevent a rotational movement of the child seat. The holder is preferably secured in the region of a rear parcel shelf or to the supporting structure of the motor vehicle on the rear side of a vehicle seat back. As a rule, the child seat is additionally secured on the supporting structure of the motor vehicle by what is referred to as an isofix anchoring device or a seatbelt on the vehicle. The holder according to the invention prevents the receiving region of the holder, if large forces act on the holder, from moving together with the securing element secured thereon towards the supporting structure to the extent that the securing element comes into contact with the supporting structure. The spacer device therefore provides a sufficient clearance for the securing element.

In a preferred exemplary embodiment of the holder, the spacer device has at least one spacer section which is angled away from a receiving section of the holder in the direction of the supporting structure. This ensures that, even if large tensile forces are transmitted via the securing element to the receiving section, a sufficient distance is maintained between the receiving section and the supporting structure. The securing element is therefore reliably prevented from coming into contact with the supporting structure.

In a further preferred exemplary embodiment of the holder, the spacer device has two spacer sections which are angled away from a receiving section of the holder in the direction of the supporting structure. By means of the two spacer sections which are angled away from the receiving section in an essentially U-shaped manner, an undesired movement of the receiving section relative to the supporting structure under tensile loading is reliably prevented.

In a further preferred exemplary embodiment of the holder, the two spacer sections are arranged parallel to each other. This provides, between the spacer sections, an essentially cuboidal receiving space for the free end of the securing element which is preferably of hook-shaped design.

In a further preferred exemplary embodiment of the holder, the receiving section comprises a square cutout to fit a hook-shaped securing element in. This makes it possible for the securing element to be secured on the receiving section in a simple manner.

In a further preferred exemplary embodiment of the holder, the receiving section is connected integrally to a securing section via a connecting section. The holder is preferably a bent punched part made of steel plate.

In a further preferred exemplary embodiment of the holder, the connecting section is arranged at an obtuse angle to the securing section. This arrangement has proven particularly advantageous within the context of the present invention.

In a further preferred exemplary embodiment of the holder, the angle which is enclosed between the connecting section and the securing section is between 90 and 120°. The angle is preferably approximately 100°.

In a further preferred exemplary embodiment of the holder, the receiving section is arranged at an obtuse angle to the connecting section. This arrangement has proven particularly advantageous within the context of the present invention.

Finally, in a further preferred exemplary embodiment of the holder, the angle which is enclosed between the connecting section and the receiving section is between 120 and 160°. The angle is preferably approximately 145°.

Further advantages, features and details of the invention emerge from the description below in which an exemplary embodiment is described in detail with reference to the drawing. In this case, the features mentioned in the claims and in the description can in each case be essential to the invention individually in themselves or in any desired combination.

### BRIEF DESCRIPTION OF THE DRAWINGS

FIG. 1 shows a perspective illustration of a holder according to the invention;

FIG. 2 shows the holder of FIG. 1 in the front view;

FIG. 3 shows the holder of FIG. 1 in a rear view;

FIG. 4 shows the holder of FIG. 1 in a side view from the left, and

FIG. 5 shows the side view of FIG. 4 in a fitted state of the holder.

### DETAILED DESCRIPTION OF THE INVENTION

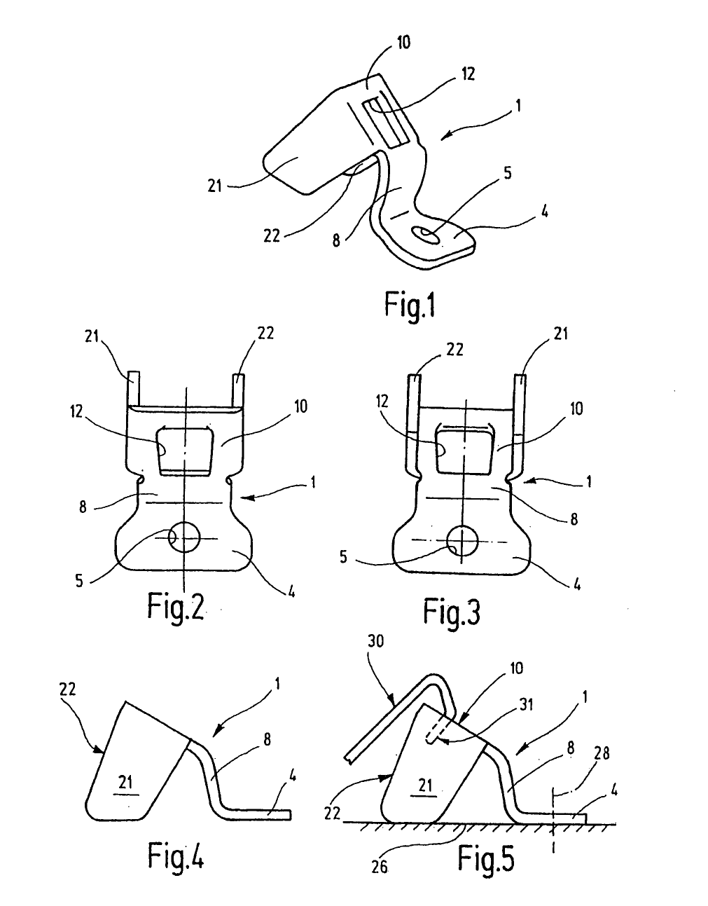

FIG. 1 illustrates a top tether holder 1 according to the invention perspectively. The top tether holder 1, which is referred to in short below as holder, has a securing section 4 with a through-hole 5. The through-hole 5 serves for the passage of a securing means, such as a screw, with which the holder 1 can be secured on a supporting structure of a motor vehicle. The securing section 4 is formed integrally with a connecting section 8. The connecting section 8 is angled away from the securing section 4 at an angle of approximately 1000 and is essentially in the form of a rectangular plate.

The connecting section 8 is connected integrally to a receiving section 10. The receiving section 10 is angled away from the connecting section 8 at an angle of approximately 145° and is essentially in the form of a rectangular plate with a central square cutout 12. By means of the cutout 12, the receiving section 10 obtains the form of a frame which bounds the cutout 12.

Two spacer tongues 21 and 22 are in each case angled away from the sides of the receiving section 10 at a right angle. The receiving section 10 and the spacer tongues 21 and 22 together have a U-shaped cross section.

FIG. 2 illustrates the holder from FIG. 1 in the front view. FIG. 3 illustrates the holder from FIG. 1 in the rear view. FIG. 4 illustrates the holder from FIG. 1 in a side view from the left.

In FIG. 5, the holder 1 is illustrated in the fitted state in the same side view as in FIG. 4. In the fitted state, the securing section 4 bears with its lower side against a supporting structure 26 of a motor vehicle. The securing section 4 is secured on the supporting structure 26 with the aid of a screw connection 28 (illustrated in simplified form). In the fitted state, the free ends of the spacer tongues 21 and 22 bear against the supporting structure 26. The supporting structure 26 extends in the horizontal direction in FIG. 5. In reality, however, the supporting structure 26 does not run in the horizontal direction but rather, for example, at an angle of approximately 70 to 80° to the horizontal.

The free end 31 of a top tether hook 30 is hooked, as indicated by dashed lines, into the cutout of the receiving section 10. If the top tether hook 30 is subjected to a tensile load, then a force acts on the receiving section 10, which force could deform the receiving section 10 towards the supporting structure 26 if the spacer tongues 21 and 22 were not preventing it.

The securing of child seats on the upper region of the backrest of the child seat with the aid of a strap webbing is controlled, depending on the country, by means of legal stipulations. The belt webbing is generally connected captively to the child seat. The “top tether hook” is secured on the free end of the belt webbing. This hook, which is denoted by 30 in FIG. 5, is fitted into the holder 1 according to the invention. In the installed state, the holder 1 is generally secured in the region of a rear parcel shelf or on the rear side of a vehicle seat back. As a rule, the child seat is additionally fixed by an “isofix anchorage” or by a seatbelt on the vehicle. By means of the top tether hook 30 hooked into the holder 1, a rotation of the child seat if severe decelerations occur is significantly reduced.

The holder 1 according to the invention provides a constructively predetermined clearance for the fitted hook 30 between the two spacer tongues 21 and 22. It is therefore ensured during routine loading that the hook 30 is only loaded in a constructively provided radius range. The spacer tongues 21 and 22 ensure, when the hook 30 is subjected to a tensile loading, that the free end 31 of the hook 30 does not come into contact with the supporting structure 26.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A holder for a securing element of a child seat, the holder serving to hold the upper region of a backrest of the child seat on a supporting structure of a motor vehicle, the holder comprising:
a receiving region for the securing element, and
a spacer device by which, when the holder is fitted to the supporting structure of the motor vehicle, the receiving region is held at a predetermined distance from the supporting structure.

2. The holder according to claim 1, wherein the spacer device has at least one spacer section which is angled away from a receiving section of the holder in the direction of the supporting structure.

3. The holder according to claim 1, wherein the spacer device has two spacer sections which are angled away from a receiving section of the holder in the direction of the supporting structure.

4. The holder according to claim 3, wherein the two spacer sections are arranged parallel to each other.

5. The holder according to claim 2, wherein the receiving section comprises a square cutout to fit a hook-shaped securing element therein.

6. The holder according to claim 2, wherein the receiving section is connected integrally to a securing section via a connecting section.

7. The holder according to claim 6, wherein the connecting section is arranged at an obtuse angle to the securing section.

8. The holder according to claim 7, wherein the angle which is enclosed between the connecting section and the securing section is between 90° and 120°.

9. The holder according to claim 6, wherein the receiving section is arranged at an obtuse angle to the connecting section.

10. The holder according to claim 9, wherein the angle which is enclosed between the connecting section and the receiving section is between 120 and 160°.

11. The holder according to claim 3, wherein the receiving section comprises a square cutout to fit a hook-shaped securing element therein.

12. The holder according to claim 4, wherein the receiving section comprises a square cutout to fit a hook-shaped securing element therein.

13. The holder according to claim 3, wherein the receiving section is connected integrally to a securing section via a connecting section.

14. The holder according to claim 4, wherein the receiving section is connected integrally to a securing section via a connecting section.

15. The holder according to claim 5, wherein the receiving section is connected integrally to a securing section via a connecting section.

16. The holder according to claim 13, wherein the connecting section is arranged at an obtuse angle to the securing section.

17. The holder according to claim 14, wherein the connecting section is arranged at an obtuse angle to the securing section.

18. The holder according to claim 15, wherein the connecting section is arranged at an obtuse angle to the securing section.

19. The holder according to claim 16, wherein the angle which is enclosed between the connecting section and the securing section is between 90° and 120°.

20. The holder according to claim 17, wherein the angle which is enclosed between the connecting section and the securing section is between 90° and 120°.
